(19) United States
(12) Patent Application Publication
(10) Pub. No.: US 2010/0253064 A1
(43) Pub. Date: Oct. 7, 2010

(54) QUICK-CONNECT TUBE FITTING CONNECTION INCLUDING A SAFETY RING

(76) Inventor: Philippe Le Quere, Betton (FR)

Correspondence Address: JOHN MOLNAR JR., PARKER-HANNIFIN CORPORATION, 6035 PARKLAND BOULEVARD, CLEVELAND, OH, 44124-4141, US

(21) Appl. No.: 12/780,218

(22) Filed: May 14, 2010

(30) Foreign Application Priority Data
Nov. 15, 2007 (FR) 0708010
Nov. 6, 2008 (FR) PCT/FR2008/001565

(51) Int. Cl. F16L 25/00; B23P 17/04

(52) U.S. Cl. 285/3; 29/428

(57) ABSTRACT

A quick-coupling tube fitting for coupling a tube to a body having a bore. The fitting includes a retaining member received within the bore for retaining the tube, and a release member received within the bore to be slidably moveable to release the retaining member when pushed. The release member has a rear portion that projects outwardly from the body. The rear portion has a shoulder surface which faces a stationary surface of the body to define a groove therebetween in which a safety member is disposed to delimit the sliding of the release member. The safety member is provided in the form of an elongate member which is closable to form a ring in the groove.

### CROSS-REFERENCE TO RELATED APPLICATIONS

This application is continuation of co-pending International Application No. PCT/FR2008/001565 filed Nov. 6, 2008, which designated the United States, and which claims priority to French Patent Application 0708010, filed Nov. 15, 2007, the disclosure of each of which is expressly incorporated herein by reference.

### BACKGROUND OF THE INVENTION

The present invention relates to a quick-coupling device for coupling a tube with a rigid element (e.g. a body of a pneumatic component such as a distributor, an actuator, etc.), and more particularly it relates to a quick-coupling device designed for anchoring a tube in a bore of the rigid element and for sealing the resulting coupling merely by pushing the tube into the bore that is fitted with the coupling device.

Quick-coupling devices of the cartridge type are known that serve to provide a leaktight connection of a tube in a bore of a rigid element, such a device being in the form of a tubular insert having outside means for permanently anchoring it in the rigid element and inside means for retaining the tube.

Those tube-retaining means are often made in the form of a washer having inside teeth, which teeth are raised in flexing when the tube is inserted, and tend to bite into the tube so as to oppose extraction thereof. When it is desired to allow the tube to be subsequently disconnected, a release pusher is made available between the tube and the insert body, which pusher can be moved in sliding to raise the teeth and thus release the tube.

Nevertheless, it is found in practice that the pusher can be pushed in accidentally, leading to the tube being disconnected in untimely manner. Such accidental disconnection may have severe consequences insofar as it leads not only to the appearance of major leaks that may constitute a source of pollution for the environment of the coupling, but it can also cause the pneumatic component that is fed via the coupling to be taken out of operation.

Numerous competing solutions exist for constituting an obstacle to sliding the release pusher. Mention may be of those constituted by an intermediate ring that is placed on fabrication of coupling members behind the head of the pusher, between said head and a stationary surface of the coupling or of the member to which it is fitted, which ring is suitable for being broken, as described in document FR 2 772 458, by means of a tool in order to restore to the pusher its function of releasing tension. Mention should also be made of rings that are put into place after the connection has been made. They usually comprise a kind of clip for preventing the pusher from sliding, which clip is releasably fitted on the device, behind the head of the pusher. Such solutions are disclosed in documents U.S. Pat. No. 6,065,779 and GB 2 301 158.

In addition to avoiding accidental disconnection, the safety means that form an obstacle to the pusher sliding need also to constitute an indicator that the connection has not been tampered with. That is not possible with devices that are fitted onto the coupling after the connection has been made. That can be done only with pusher-blocking members that are installed on a coupling at the time of fabrication for the purpose of making the connection non-releasable unless the safety ring is broken, with the ring then constituting a tamper proofing ring. Such couplings require a fabrication line that is different from couplings that do not need to provide this safety function, and that goes against standardizing production and leads to higher fabrication costs. Furthermore, that safety ring is not applicable to couplings in which the tube is retained by a hooking clamp that possesses teeth at the end of arms that are movable radially, and that in order to operate require the clamp to be moved in axial translation by the tube when the tube is inserted so that the teeth can splay apart in a peripheral recess provided for that purpose in the insert. Opposite from the teeth, the clamp has a head that forms a pusher for disconnection, the head being used to push the clamp back towards the recess so as to enable the teeth once more to move away from the tube and release the tube in which they were previously constrained to bite during the first movement of extracting the tube that the assembler performed in order to complete making the connection. It can be understood that a safety ring presenting any axial movement of the clamp cannot be suitable.

An aim of the present invention is to improve the safety of so-called “quick-coupling” devices by preventing accidental or malicious pushing in of the release pusher for releasing the retaining washer, by constituting a tamper proofing indicator for the connection while also being suitable for being installed on the coupling after the connection has already been made.

### SUMMARY OF THE INVENTION

The invention provides a quick-coupling tube fitting connection for coupling a tube end to a rigid element or body having a bore. In an illustrative embodiment, the device includes a tubular insert possessing outside means for anchoring it in the bore of the rigid element, declutchable inside means for retaining the tube, and release means mounted to move in translation relative to the rigid element to release the retaining means when pushed into the tubular insert, the release means possessing a rear portion that projects outside the element and that presents a shoulder surface situated facing a stationary surface of the element or the tubular insert, a groove thus being defined between them in which an intermediate obstacle is housed to oppose sliding of the release means, wherein said obstacle is an elongate member closed in a loop to form a ring in the groove by means of definitive connection means, the ring including a portion of reduced tensile strength.

Thus, as in the prior art, any force directed to pushing in the release pusher leads to the surface of the pusher shoulder being brought to bear against the removable intermediate ring, which itself bears against the above-mentioned stationary surface. In contrast, in original manner, the intermediate ring is fitted onto a coupling that is of standard fabrication and therefore of low cost, by making an irreversible connection between the two free ends of a link that is placed in the above-mentioned groove and that constitutes an in situ ring or loop. The portion having low tensile strength of the link or of the ring when the link is looped constitutes a zone of weakness where it is easy to break the ring if it is desired to enable the pusher to slide so as to release the teeth.

Each free end of the elongate member, prior to closure, is provided with a connection element that is suitable for being associated in definitive manner with the connection element at the other free end, by means of complementary shapes.

Prior to being looped, the elongate member has two branches, each in the form of a rigid semicircular clip, which branches are connected together at one of their ends by a radially outer peripheral link at said ends, which ends bear against each other when the elongate member is looped, with the other ends of the clips being provided with inseparable end-to-end snap-fastener means.

Once the snap-fastener means have been engaged, it is advantageous for the peripheral link that constitutes the mechanically weakened portion of the ring to be under tension.

In an alternative embodiment, the ends of the branches beside the link co-operate by mutual engagement under the link. This engagement may be circumferential snap-fastening of the two ends, which can be separated by being pulled tangentially, or else centering engagement of the two ends one within the other when they are caused to press against each other while the ring is being put into place.

In another variant embodiment, each of the clips is fitted with at least one flexible lateral skirt that covers the head of the release pusher.

Finally, a second embodiment of the ring of the invention is mentioned that consists in a flexible link of thickness that is substantially equal to the width of the above-defined groove, with one of the ends of the link being provided with an eyelet through which the other end can be threaded, which other end is provided with a succession of portions in relief enabling it to be held in place by co-operating between the edges of the eyelet and the edge of the portions in relief that have passed through the opening and is adjacent thereto. The zone of weakness is then at the base of said adjacent portion in relief such that tensile applied to the end where it projects beyond the eyelet causes the ring to break beneath the eyelet. That type of ring can also be opened by a sharp tool for cutting off the end of the link flush with the eyelet.

The present invention, accordingly, comprises the construction, combination of elements, and/or arrangement of parts and steps which are exemplified in the detailed disclosure to follow.

### BRIEF DESCRIPTION OF THE DRAWINGS

For a fuller understanding of the nature and objects of the invention, reference should be had to the following detailed description taken in connection with the accompanying drawings wherein:

FIGS. 1 and 2 show two quick couplings of the prior art, without specific arrangements, neither for safety nor for tamper proofing;

FIGS. 3 and 4 are face views of a first embodiment of a safety and tamper proofing ring designed to co-operate with a device of the type shown in the preceding Figs. to form a coupling of the invention;

FIG. 5 shows a first variant of the ring of FIGS. 3 and 4;

FIG. 6 shows a second variant of said ring;

FIG. 7 shows a third embodiment of this ring; and

FIG. 8 is a section view of a coupling of the invention with a fourth variant embodiment of the ring.

The drawings will be described further in connection with the following Detailed Description of the Invention.

### DETAILED DESCRIPTION OF THE INVENTION

FIG. 1 shows a quick-coupling device for coupling a tube 1 to a rigid element 2 possessing a bore 3 in which a tubular insert 4 is housed, the insert being held in the bore by means 5 on the outside of its anchoring in the bore.

The tubular insert includes a toothed washer 6 and a sealing ring 7 is located at the tip of the insert in a recess 8 extending the bore 3. Means are provided inside the insert 4 for the purpose of releasing retention of the tube 1, which means comprise a pusher 9 mounted to move in translation inside the tubular insert 4 to release the retaining means and thus lift the teeth of the washer 6 outwards on being pushed into the tubular insert 4. The release pusher 9 possesses a rear portion or head 10 that projects outside the tubular insert 4 or the rigid element 2 and that presents a shoulder surface 10a situated facing a stationary surface 2a of the stationary element 11 or of the tubular insert, the two surfaces in the example being made to lie in like transverse planes. A groove 12 is thus defined between them.

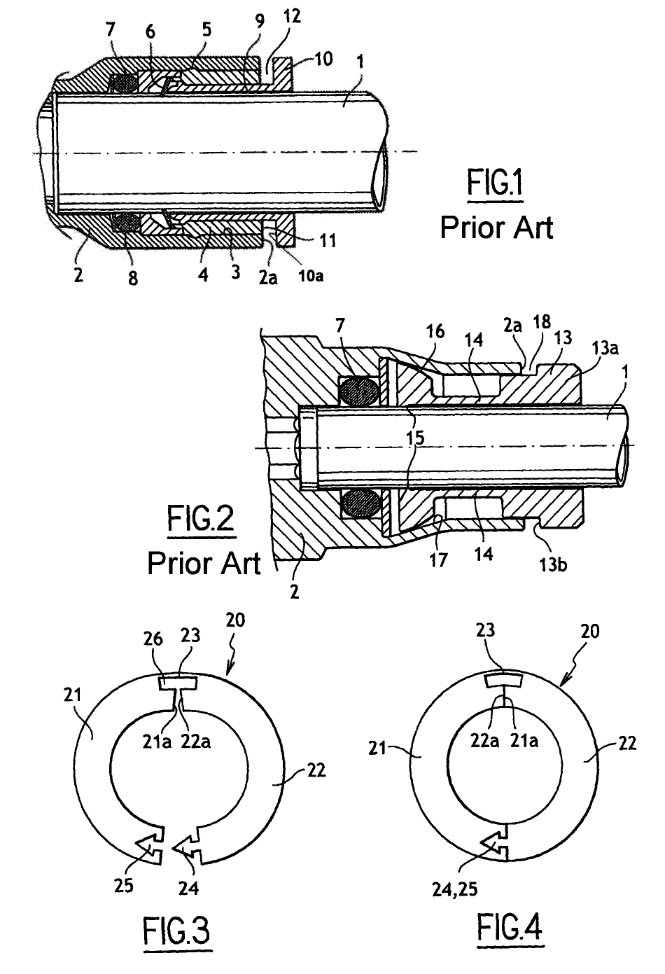

FIG. 2 shows another embodiment of a quick-coupling device in which the tube 1 is held inside the body of the rigid element 2 by a longitudinally-split bushing 13 serving to define the arms of a clamp 14 that are terminated by teeth 15 that bite into the outside surface of the tube in the event of an attempt being made to withdraw said tube, the rear sides of the teeth being constrained to clamp the tube radially by the conical wall 16 of the recess 17 in which they are contained. The end 13a of the bushing 13 remote from the teeth 15 lies outside the body of the element 1 and forms a pusher head for releasing the teeth 15. This head has a shoulder 13b that defines, as above, a groove 18 of width that corresponds to the travel distance needed for the teeth to move in translation so as to enable them to be disengaged from the wall of the tube.

The groove 12 or 18 in the above Figs. is thus the location where an intermediate obstacle is received for preventing the pusher from moving, in particular once the connection has been made. This intermediate obstacle in a first embodiment of the invention is shown in FIGS. 3 and 4.

The obstacle 20 shown is an elongate member having two branches, here in the form of two rigid half-collars 21 and 22 that are interconnected at one of their ends by means of a peripheral link 23 that presents limited tensile strength, and in register therewith there are two bearing surfaces 21a and 22a. At their other ends, the half-collars have definitive connection means, e.g. such as those shown, i.e. a barbed plunger 24 for the branch 22 that is suitable for being forcibly received in a housing 25 of complementary shape in the branch 21.

FIG. 4 shows the ring constituted by the elongate member 20 once closed in a loop, e.g. in one of the grooves 12 or 18. The inside diameter of the ring as produced in this way is substantially equal to the diameter of the bottom of the groove so that the ring forms an obstacle to the pusher sliding. It can be seen that in this state the bearing faces 21a and 22a are in contact with each other and that a opening 26 exists under the link 23 that is tensioned by closing the ring, which opening 26 is situated on a diameter that is greater than the outside diameter of the pusher head. It is then possible to insert a tool (screwdriver) into this opening, which tool can then be used by a lever effect to break the link 23 and thus enable the ring to be opened and the pusher to be moved. The ring is then no longer usable and this state of affairs informs the user of the preceding event.

In the ring shown in FIG. 5, elements common with the above-described ring are given the same references. The difference lies in the nature of the contact made under the link 23. In this variant, the ends of the branches 21 and 22 that come into contact under the link 21, when the means 24 and 25 are fastened together, comprise hook means 30 and 31, i.e. a tooth 30 on the branch 21 that catches behind a tooth 31 of the branch 22. Opening the ring requires the link to be broken as above, but removing the ring then requires the teeth 30 and 31 to be separated. The ring of FIG. 5 can be reused even though its link 23 is broken, and the broken link remains as an indication of a first opening of the ring and thus of a presumed disconnection by virtue of the pusher being allowed to move.

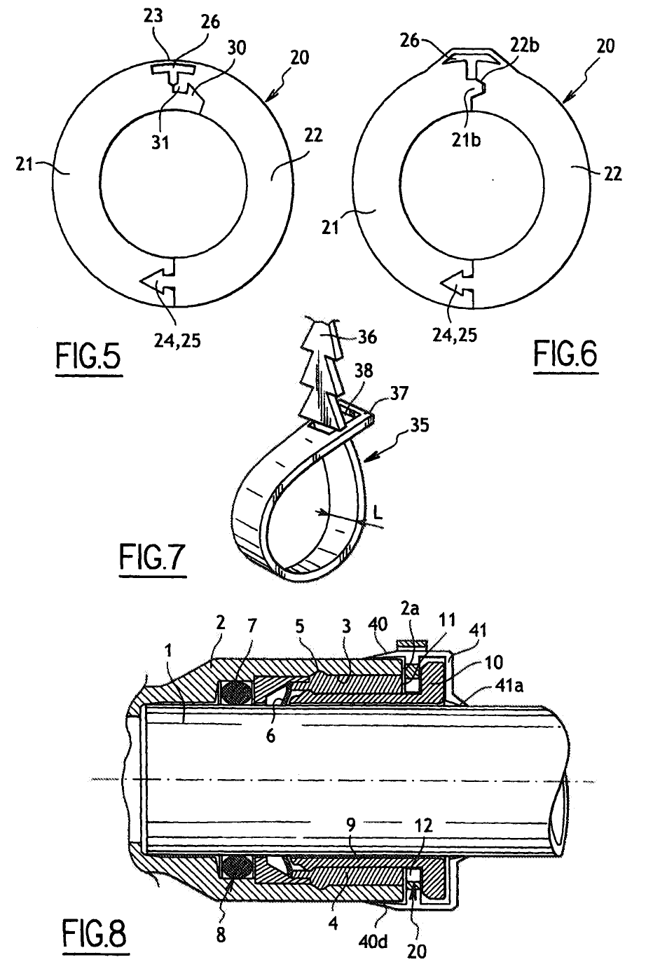

In FIG. 6, the ring shown differs from that of FIGS. 3 and 4 in the shape of its bearing surfaces 21a and 22a. Here the surfaces are formed by the flanks of a nose 21b and a groove 22b that, when the ring is closed, constitute a pseudo-hinge about which the branches pivot in order to create tension in the link 23 in a manner that is even more marked than in the example of FIGS. 3 and 4.

FIG. 7 shows an embodiment of the ring based on a flexible strip 35 having one end 36 possessing catches or portions in relief, e.g. Christmas-tree-shaped teeth, and having its other end 37 including an eyelet 38 through which the catches 36 can be forced in a manner that is non-reversible, i.e. they cannot be pulled back. The width L of the strip corresponds to the width of the grooves 12 or 18, and the ring as formed in this way can be opened by breaking the strip at the catch that has its edges bearing against the eyelet 38, either by applying tensile since the corresponding zone of the strip under the catch is weakened, or else by cutting the strip at this point. The strip can then no longer be reused. In this embodiment, it has performed the two functions it is required to perform in order to comply with the specifications (preventing the pusher from moving and acting as a tamper proofing indicator). The ring complies with the structural definition of the invention, i.e. it presents means providing a closed ring that cannot be taken apart in situ once the connection has been made, and it includes an easily-broken zone that enables it to be withdrawn to release the means for releasing retention of the tube. This embodiment may also serve as an inexpensive element serving, for example, to guarantee that the device has not been tampered with between leaving the factory and being assembled, should any movement of the pusher prior to engaging a tube present drawbacks for future use of the device.

FIG. 8 shows a coupling device of the invention in longitudinal section in which certain elements as described above are given the same references. The ring shown corresponds to that of FIG. 6. In addition to the ring of FIG. 6 it includes a front skirt 40 and a rear skirt 41, each of which is secured to the corresponding half-collar 21, 22 so as to form a shield for protecting the pusher against any dirt that might become lodged thereon while it is in use. These skirts are of dimensions such that they form deformable lips 40a and 41a that fit closely both around the tube 1 and around the rigid element 2.

As it is anticipated that certain changes may be made in the present invention without departing from the precepts herein involved, it is intended that all matter contained in the foregoing description shall be interpreted in as illustrative rather than in a limiting sense. All references including any priority documents cited herein are expressly incorporated by reference.

What is claimed is:

1. A fitting for coupling a tube end to a body having a bore with an opening into the body, the tube end being grippably retained in the bore, and the fitting comprising:
a generally annular member having a first member end received coaxially in the bore and a second member end extending outside of the bore having a shoulder surface facing a stationary surface surrounding the bore opening, the tube end being receivable coaxially through the member into the bore, and the second member end being pushable towards the stationary surface to slidably move the member over the tube from a first position wherein the shoulder surface is axially spaced-apart from the stationary surface and a second position releasing the tube end from its grippable retention in the bore; and
a safety collar disposed intermediate the stationary surface and the shoulder surface in the first position of the member for delimiting the movement of the member from the first position to the second position, the collar being formed from an elongate element having a first element end and a second element end, and an aperture through a portion thereof, the element being closed around the release member with the first member end being secured to the second member end to form a ring having a section of reduced tensile strength adjacent the aperture, the aperture being accessible on the ring to fracture the reduced tensile strength section for opening the ring and allowing its removal from the member.

2. The fitting of claim 1 wherein the first and the second element ends are interlocking.

3. The fitting of claim 1 wherein:
the ring has an outer periphery and the element being configured as a generally semi-circular first half extending from the first element end to a first half end, and a generally semi-circular second half extending from the second element end to a second half end, the first and the second half each having an outer edge which together define the outer periphery of the ring, and the first and second half end being connected along the outer edge of the first and the second half by a peripheral link portion, the link portion forming the section of reduced tensile strength in the ring; and
the first and the second half end each contacts the other when the ring is formed.

2. The fitting of claim 3 wherein the first and the second half ends are interlocking when the ring is formed.

3. The fitting of claim 3 wherein one of the first and the second half end bearingly engages the other half end when the ring is formed, such engagement tensioning the section of reduced tensile strength.

4. The fitting of claim 1 further comprises a skirt which extends from the ring to cover the second member end.

5. The fitting of claim 1 wherein:
the first element end is configured as an eyelet and the second element end is formed as a succession of engagement portions; and
the ring is formed by passing the second element end through the eyelet to interlockably engage one of the engagement portions therewith, the aperture and area of reduced tensile strength being defined by the eyelet.

6. A connection comprising:
a tube end;
a body having a bore with an opening into the body, the tube end being grippably retained in the bore; and
a fitting comprising:
a generally annular member having a first member end received coaxially in the bore and a second member end extending outside of the bore having a shoulder surface facing a stationary surface surrounding the bore opening, the tube end being receivable coaxially through the member into the bore, and the second member end being pushable towards the stationary surface to slidably move the member over the tube from a first position wherein the shoulder surface is axially spaced-apart from the stationary surface and a second position releasing the tube end from its retention in the bore; and
a safety collar disposed intermediate the stationary surface and the shoulder surface in the first position of the member for delimiting the movement of the member from the first position to the second position, the collar being formed from an elongate element having a first element end and a second element end, and an aperture through a portion thereof, the element being closed around the release member with the first member end being secured to the second member end to form a ring having a section of reduced tensile strength adjacent the aperture, the aperture being accessible on the ring to fracture the reduced tensile strength section for opening the ring and allowing its removal from the member.

7. The connection of claim 6 wherein the first and the second element ends are interlocking.

8. The connection of claim 6 wherein:
the ring has an outer periphery and the element being configured as a generally semi-circular first half extending from the first element end to a first half end, and a generally semi-circular second half extending from the second element end to a second half end, the first and the second half each having an outer edge which together define the outer periphery of the ring, and the first and second half end being connected along the outer edge of the first and the second half by a peripheral link portion, the link portion forming the section of reduced tensile strength in the ring; and
the first and the second half end each contacts the other when the ring is formed.

9. The connection of claim 8 wherein the first and the second half ends are interlocking when the ring is formed.

10. The connection of claim 8 wherein one of the first and the second half end bearingly engages the other half end when the ring is formed, such engagement tensioning the section of reduced tensile strength.

11. The connection of claim 6 further comprises a skirt which extends from the ring to cover the second member end.

12. The connection of claim 6 wherein:
the first element end is configured as an eyelet and the second element end is formed as a succession of engagement portions; and
the ring is formed by passing the second element end through the eyelet to interlockably engage one of the engagement portions therewith, the aperture and area of reduced tensile strength being defined by the eyelet.

13. A method of forming a safety collar for a fitting for coupling a tube end to a body having a bore with an opening into the body, the tube end being grippably retained in the bore, and the fitting comprising a generally annular member having a first member end received coaxially in the bore and a second member end extending outside of the bore having a shoulder surface facing a stationary surface surrounding the bore opening, the tube end being receivable coaxially through the member into the bore, and the second member end being pushable towards the stationary surface to slidably move the member over the tube from a first position wherein the shoulder surface is axially spaced-apart from the stationary surface and a second position releasing the tube end from its grippable retention in the bore, the safety collar being disposed intermediate the stationary surface and the shoulder surface in the first position of the member for delimiting the movement of the member from the first position to the second position, method comprising the steps of:
(a) providing an elongate element having a first element end and a second element end, and an aperture through a portion thereof;
(b) closing the element around the release member intermediate the stationary surface and the shoulder surface in the first position of the member;
(c) securing the first member end to the second member end to form a ring having a section of reduced tensile strength adjacent the aperture, the aperture being accessible on the ring to fracture the reduced tensile strength section for opening the ring and allowing its removal from the member.

14. The method of claim 13 wherein the first and the second element ends are interlocked when the ring is formed in step (c).

15. The method of claim 13 wherein:
the ring has an outer periphery and the element being configured as a generally semi-circular first half extending from the first element end to a first half end, and a generally semi-circular second half extending from the second element end to a second half end, the first and the second half each having an outer edge which together define the outer periphery of the ring, and the first and second half end being connected along the outer edge of the first and the second half by a peripheral link portion, the link portion forming the section of reduced tensile strength in the ring; and
the first and the second half end each contacts the other when the ring is formed in step (c).

16. The method of claim 15 wherein the first and the second half ends are interlocked when the ring is formed in step (c).

17. The method of claim 15 wherein one of the first and the second half end bearingly engages the other half end when the ring is formed in step (c), such engagement tensioning the section of reduced tensile strength.

18. The method of claim 13 wherein the fitting further comprises a skirt which extends from the ring to cover the second member end.

19. The method of claim 13 wherein:
the first element end is configured as an eyelet and the second element end is formed as a succession of engagement portions;
the ring is closed in step (c) by passing the second element end through the eyelet; and
the ring is formed in step (c) by interlockingly engaging one of the engagement portions with the eyelet, the aperture and area of reduced tensile strength being defined by the eyelet.

20. The method of claim 13 further comprising the additional steps:
(d) accessing the aperture on the ring to fracture the reduced tensile strength section;
(e) opening the ring; and
(f) removing the ring from the member.
